(19) United States
(12) Patent Application Publication
(10) Pub. No.: US 2021/0387314 A1
(43) Pub. Date: Dec. 16, 2021

(54) PAWL AND SWITCH OF A RATCHET WRENCH

(71) Applicant: Yi-Min Li, Taichung (TW)

(72) Inventor: Yi-Min Li, Taichung (TW)

(21) Appl. No.: 16/898,398

(22) Filed: Jun. 10, 2020

(51) Int. Cl. B25B 13/46; B25B 23/00

(52) U.S. Cl. CPC B25B 13/463; B25B 23/0007

(57) ABSTRACT

A ratchet wrench includes a handle, a gear, a pawl and a switch. The handle includes a box formed at an end. The gear, the pawl and the switch are inserted in the box. The pawl includes teeth, two blocks and a fin. The teeth of the pawl are for engagement with teeth of the gear. The blocks are formed at two ends of the pawl. The fin extends opposite to the teeth of the pawl. The switch includes a lever, a crank and a groove. The lever extends from an upper portion in a radial direction so that the lever is operable to rotate the entire switch. The crank extends from a lower portion in another radial direction so that the crank is abutted against one of the blocks to move the pawl to one of two positions. The groove receives the fin.

### BACKGROUND OF INVENTION

### 1. Field of Invention

The present invention relates to a ratchet wrench and, more particularly, to a pawl and a switch of a ratchet wrench.

### 2. Related Prior Art

A conventional ratchet wrench includes a handle, a gear, a pawl and a switch. The handle includes a box formed at an end. The gear, the pawl and the switch are inserted in the box. The pawl is engaged with or disengaged from the gear in operation. The pawl includes a cutout in a substantially convex side and two blocks are formed at two opposite ends of the pawl. The switch includes a lever and a crank. The lever extends from an upper portion of the switch in a radial direction. The crank extends from a lower portion of the switch in another radial direction. The crank is movably inserted in the cutout. The lever is operable to pivot the entire switch. Accordingly, the crank abuts one of the blocks to move the pawl to one of two positions. However, the use of this conventional ratchet wrench is not without any problem. For example, the pawl could rattle up and down relative to the switch in operation, and this is undesirable.

The present invention is therefore intended to obviate or at least alleviate the problems encountered in prior art.

### SUMMARY OF INVENTION

It is the primary objective of the present invention to provide a reliable ratchet wrench.

To achieve the foregoing objective, the ratchet wrench includes a handle, a gear, a pawl and a switch. The handle includes a box formed at an end. The gear, the pawl and the switch are inserted in the box. The pawl includes teeth, two blocks and a fin. The teeth of the pawl are for engagement with teeth of the gear. The blocks are formed at two ends of the pawl. The fin extends opposite to the teeth of the pawl. The switch includes a lever, a crank and a groove. The lever extends from an upper portion in a radial direction so that the lever is operable to rotate the entire switch. The crank extends from a lower portion in another radial direction so that the crank is abutted against one of the blocks to move the pawl to one of two positions. The groove receives the fin.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a ratchet wrench according to the preferred embodiment of the present invention;

FIG. 2 is a partial exploded view of the ratchet wrench shown in FIG. 1;

FIG. 3 is a cross-sectional view of the ratchet wrench of FIG. 1; and

FIG. 4 is a cross-sectional view of the ratchet wrench shown in FIG. 1.

### DETAILED DESCRIPTION OF PREFERRED EMBODIMENT

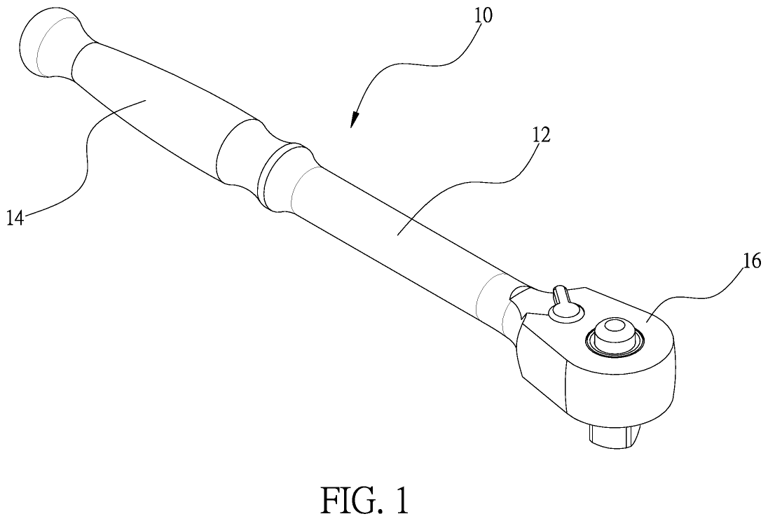

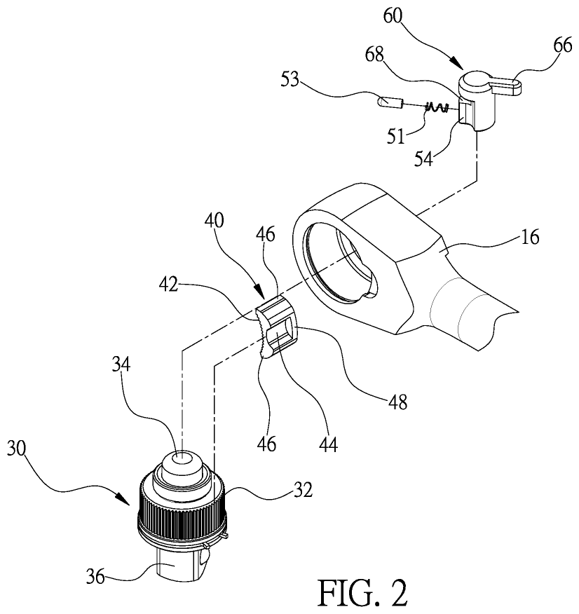

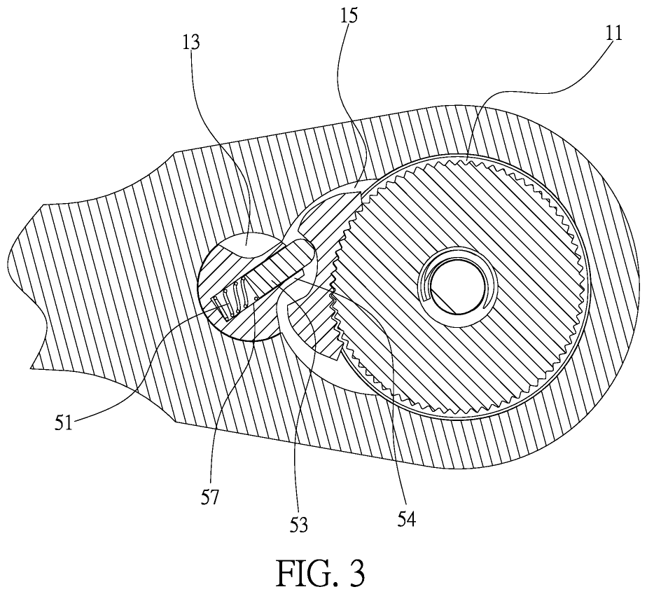

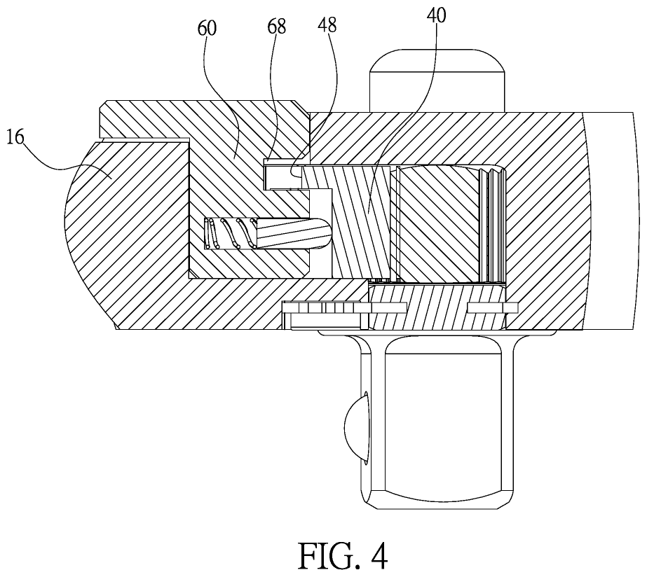

Referring to FIGS. 1 through 4, a ratchet wrench 10 includes a handle (not numbered), a gear 30, a pawl 40 and a switch 60 according to the preferred embodiment of the present invention. The handle includes a shank 12 formed between a grip 14 and a hollow head or box 16. The shank 12, the grip 14 and the box 16 are made in one piece. The grip 14 is operable to pivot the box 16 via the shank 12, thereby rotating a threaded bolt or a nut for example.

The box 16 is formed with a lower face (not numbered), an upper face (not numbered), a gear chamber 11, a switch chamber 13 and a pawl chamber 15. The gear chamber 11 is a circular chamber that includes a lower open end in the lower face of the box 16 and an upper open end in the upper face of the same. The upper open end of the gear chamber 11 is made with a diameter smaller than that of the lower open end of the same. The switch chamber 13 is a circular chamber that includes a lower open end in the lower face of the box 16 and an open upper end in the upper face of the same. The upper open end of the switch chamber 13 is made with a diameter smaller than that of the lower open end of the same. The pawl chamber 15 is a crescent chamber with a closed upper end at the upper face of the box 16 and an open lower end in the lower face of the box 16. The pawl chamber 15 is in communication with the gear chamber 11 on a side and in communication with the switch chamber 13 on another side.

The gear 30 is formed with teeth 32, an axle 34 and a square insert 36. The teeth 32 are formed on the periphery of the gear 30. The axle 34 extends from an upper face of the gear 30. The square insert 36 extends from a lower face of the gear 30.

The gear 30 is rotationally inserted in the gear chamber 11. The axle 34 extends from the gear chamber 11 through the upper open end of the gear chamber 11. The square insert 36 extends from the gear chamber 11 through the lower open end of the gear chamber 11.

The pawl 40 is formed with a concave side (not numbered) and a substantially convex side (not numbered). Teeth 42 are formed on the concave side of the pawl 40. A cutout 44 is made in the substantially convex side of the pawl 40. Two blocks 46 are formed at two opposite ends of the pawl 40. The cutout 44 is located between the blocks 46. A fin 48 is formed on the substantially convex side of the pawl 40, above the cutout 44, between the blocks 46.

The pawl 40 is movably inserted in the pawl chamber 15. The teeth 42 are engaged with the teeth 32.

The switch 60 includes a lever 66, a groove 68 and a crank 54. The lever 66 extends from an upper portion of the switch 60 in a radial direction. The crank 54 extends from a lower portion of the switch 60 in another radial direction.

Preferably, a spring 51 is inserted in a cavity 57 made in the crank 54 so that a rear end of the spring 51 is abutted against a closed end of the cavity 57. Moreover, a rod 53 includes a rear end abutted against a front end of the spring 51 and a front end extending from the cavity 57 through an open end of the cavity 57. The front end of the rod 53 is movably inserted in the cutout 44. The front end of the rod 53 is abutted against one of the blocks 46 to move the pawl 40 to one of two positions.

The lower portion of the switch 60 is pivotally inserted in the switch chamber 13 so that the upper portion of the switch 60 extends from the switch chamber 13 via the upper open end of the switch chamber 13. The lever 66 is located out of the switch chamber 13. The lever 66 is operable to pivot the switch 60. The groove 68 receives the fin 48. Thus, the pawl 40 does not rattle up and down relative to the switch 60 in operation. Accordingly, the switch 60 is smooth rotatable relative to the pawl 40.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A ratchet wrench comprising:
a handle comprising a box formed at an end;
a gear inserted in the box;
a pawl inserted in the box, wherein the pawl comprises:
teeth for engagement with teeth of the gear;
two blocks formed at two ends of the pawl; and
a fin opposite to the teeth of the pawl; and
a switch inserted in the box, wherein the switch comprises:
a lever extending from an upper portion of the switch in a radial direction so that the lever is operable to rotate the entire switch;
a crank extending from a lower portion of the switch in another radial direction so that the crank is abutted against one of the blocks to move the pawl to one of two positions; and
a groove for receiving the fin.

2. The ratchet wrench according to claim 1, wherein the groove is located between the lever and the crank.
